(19) United States
(12) Patent Application Publication
(10) Pub. No.: US 2005/0184646 A1
(43) Pub. Date: Aug. 25, 2005

(54) Electron emission device and method of manufacturing the same

(76) Inventor: Ki-Hyun Noh, Suwon-si (KR)

Correspondence Address: CHRISTIE, PARKER & HALE, LLP, PO BOX 7068, PASADENA, CA, 91109-7068, US

(21) Appl. No.: 11/061,188

(22) Filed: Feb. 16, 2005

(30) Foreign Application Priority Data
Feb. 20, 2004 (KR) 10-2004-0011390

(51) Int. Cl. H01J 1/62

(52) U.S. Cl. 313/497; 313/495

(57) ABSTRACT

An electron emission device includes cathode electrodes formed on a substrate, and gate electrodes placed over the cathode electrodes while interposing an insulating layer. The gate electrodes and the insulating layer have holes partially exposing the cathode electrodes. Electron emission regions are electrically connected to the portions of the cathode electrodes exposed through the holes of the insulating layer and the gate electrodes. A nonconductive protective layer is formed on the top surface of the gate electrodes and the inner sidewall of the holes.

### CROSS REFERENCE TO RELATED APPLICATION

This application claims priority to and the benefit of Korean Patent Application No. 10-2004-0011390 filed on Feb. 20, 2004 in the Korean Intellectual Property Office, the entire content of which is incorporated herein by reference.

### BACKGROUND OF THE INVENTION

1. Field of the Invention

The present invention relates to an electron emission device, and in particular, to an electron emission device which prevents electrodes and electron emission region from being damaged during the process of forming the electron emission region.

2. Description of Related Art

Generally, the electron emission devices are classified into a first type where a hot cathode is used as electron emission regions, and a second type where a cold cathode is used as the electron emission region.

Among the second type of electron emission devices, a field emitter array (FEA) type, a surface conduction emitter (SCE) type, a metal-insulator-metal (MIM) type, a metal-insulator-semiconductor (MIS) type, and a ballistic electron surface emitting (BSE) type are known.

The electron emission devices are differentiated in their specific structure depending upon the types thereof, but basically have an electron emission unit placed within a vacuum vessel, and a light emission unit facing the electron emission unit in the vacuum vessel.

With the FEA type electron emission device, driving voltages are applied to the driving electrodes placed around the electron emission region to form electric fields, and electrons are emitted from the electron emission region due to the electric fields.

In order to make the electron emission region for the FEA type electron emission device, it has been proposed to use either a technique of making an electron emission material in the shape of a paste and pattern-printing it, or a technique of making an electron emission material in the shape of a photosensitive paste, and photo-processing it.

With the above techniques, a sacrificial layer is introduced to form the electron emission region. The sacrificial layer is mainly formed with a thin film of metal, such as aluminum. As such a sacrificial layer is formed with a conductive material, it should be necessarily removed after the formation of the electron emission region.

An etching solution is commonly used to remove the sacrificial layer. In this case, the electrodes and the electron emission region are liable to be damaged due to the etching solution. Consequently, the line resistance is increased due to the damages to the electrodes, and the amount of electron emission is decreased due to the damages to the electron emission region. Furthermore, the contact resistance between the electron emission region and the cathode electrodes is liable to be increased.

In addition, when the electron emission material is fired before the removal of the sacrificial layer, the electrodes are liable to be oxidized.

### SUMMARY OF THE INVENTION

In one embodiment, the present invention is an electron emission device which prevents electrodes and electron emission region from being damaged during the process of forming the electron emission region.

According to one aspect of the present invention, the electron emission device includes cathode electrodes formed on a substrate, and gate electrodes placed over the cathode electrodes while interposing an insulating layer. The gate electrodes and the insulating layer have holes partially exposing the cathode electrodes. Electron emission regions are electrically connected to the portions of the cathode electrodes exposed through the holes of the insulating layer and the gate electrodes. A nonconductive protective layer is formed on the top surface of the gate electrodes and the inner sidewall of the holes.

The protective layer is formed with amorphous silicon a-Si or photoresist.

With a method of manufacturing the electron emission device, cathode electrodes are first formed on a substrate. An insulating layer and gate electrodes with holes are sequentially formed on the cathode electrodes. A nonconductive protective layer is formed on the top surface of the gate electrodes and the inner sidewall of the holes. Electron emission regions are formed on the portions of the cathode electrodes exposed through the holes.

The protective layer is formed with amorphous silicon by way of plasma enhanced chemical vapor deposition or is formed with photoresist by way of coating.

According to another aspect of the present invention, the electron emission device includes gate electrodes formed on a substrate, and cathode electrodes placed over the gate electrodes while interposing an insulating layer. A nonconductive protective layer covers the cathode electrodes. Electron emission regions are formed with a photosensitive electron emission material. The electron emission regions are electrically connected to the cathode electrodes to emit electrons.

The protective layer is formed with amorphous silicon a-Si or photoresist.

Electron emission region accommodating members are formed through partially removing the cathode electrodes, and the electron emission regions are placed at the electron emission region accommodating members.

The cathode electrodes have a double-layered structure with a first metallic layer, and a second metallic layer. The first metallic layer is formed with aluminum, and the second metallic layer is formed with chromium.

Counter electrodes are spaced apart from the electron emission regions with a distance between the cathode electrodes. The counter electrodes contact the gate electrodes through the holes formed at the insulating layer to make an electrical connection with the gate electrodes. The counter electrodes have a double-layered structure with an aluminum-based layer, and a chromium-based layer.

With a method of manufacturing the electron emission device, gate electrodes are first formed on a substrate. An insulating layer is formed on the entire surface of the substrate such that the insulating layer covers the gate electrodes. Cathode electrodes are formed on the insulating layer. A nonconductive protective layer is formed on the insulating layer overlaid with the cathode electrodes, and patterned. An electron emission material is coated on the protective layer and the substrate, and exposed to light by way of backside exposure to form electron emission regions.

The step of forming a protective layer is performed by depositing an amorphous silicon layer through plasma enhanced chemical vapor deposition and patterning the layer through dry etching, or is performed by coating a photoresist layer and patterning the photoresist layer through photolithography process.

The step of forming cathode electrodes is performed by sequentially depositing a first aluminum-based metallic layer and a second chromium-based metallic layer, and patterning the first and the second metallic layers.

When the cathode electrodes are formed, electron emission region accommodating members, counter electrodes and electric field reinforcing members may be further formed.

### BRIEF DESCRIPTION OF THE DRAWINGS

The above and other advantages of the present invention will become more apparent by describing preferred embodiments thereof in detail with reference to the accompanying drawings in which;

FIG. 1 is a cross sectional view of an electron emission device according to a first embodiment of the present invention;

FIGS. 2A, 2B, and 2C schematically illustrate the respective steps of processing the electron emission device according to the first embodiment of the present invention;

FIG. 3 is an exploded perspective view of an electron emission device according to a second embodiment of the present invention;

FIGS. 4A, 4B, and 4C schematically illustrate the respective steps of processing the electron emission device according to the second embodiment of the present invention;

FIG. 5 is a cross sectional view of an electron emission device according to a third embodiment of the present invention;

FIGS. 6A, 6B, and 6C schematically illustrate the respective steps of processing the electron emission device according to the third embodiment of the present invention; and

FIG. 7 is a cross sectional view of an electron emission device according to a fourth embodiment of the present invention.

### DETAILED DESCRIPTION

FIG. 1 is a cross sectional view of an electron emission device according to a first embodiment of the present invention.

As shown in FIG. 1, the electron emission device has a first and a second substrate 12 and 14 spaced apart from each other with a predetermined distance. The first and the second substrates 12 and 14 proceed substantially parallel to each other, and are sealed to form a vacuum vessel outlining the electron emission device.

An electron emission unit is provided at the first substrate 12 to emit electrons toward the second substrate 14, and a light emission unit is provided at the second substrate 14 to emit visible rays, thereby displaying the desired images.

Specifically, cathode electrodes 16 with a predetermined pattern (for instance, a stripe pattern) are formed on the first substrate 12 such that they are spaced apart from each other at a distance. An insulating layer 18 is formed on the surface of the first substrate 12 such that it covers the cathode electrodes 16. Gate electrodes 20 are formed on the insulating layer 18 while crossing the cathode electrodes 16.

The crossed regions of the cathode electrodes 16 and the gate electrodes 20 are defined as pixel regions. At least one hole 22 is formed at the gate electrode 20 and the insulating layer 18 per the respective pixel regions while exposing the cathode electrode 16. Electron emission region 24 is formed on the exposed portions of the cathode electrodes 16. Thus the electron emission region 24 is electrically connected to the cathode electrodes 16.

The electron emission region 24 is formed with a carbon-based material, which is selected from carbon nanotube, graphite, diamond, diamond-like carbon, C₆₀ (fulleren), or combinations thereof. Also, the electron emission region 24 is formed with a nanometer size material, which is selected from nano-tube, nano-fiber, or combination thereof.

A protective layer 26 covers the top surface of the gate electrodes 20, and the inner sidewall of the holes 22. In this embodiment, the protective layer 26 is formed with amorphous silicon a-Si by way of plasma enhanced chemical vapor deposition (PECVD), or with photoresist by way of coating.

A light emission unit is formed at the second substrate 14 facing the first substrate 12. Phosphor layers 30a and black layers 30b are formed on the inner surface of the second substrate 14, and an anode electrode 28 covers the phosphor layers 30a and the black layers 30b. The anode electrode 28 may be formed with metal, such as aluminum. The anode electrode 28 receives the voltage required for accelerating the electron beams, and has a role of heightening the screen brightness by way of a metal back effect.

The anode electrode may be alternatively formed with a transparent conductive material, such as indium tin oxide ITO. In this case, the transparent conductive anode electrode (not shown) is first formed on the second substrate, and the phosphor layers and the black layers are then formed on the anode electrode. Furthermore, a metallic layer may be formed on the phosphor layers and the black layers to heighten the screen brightness. The anode electrode may be singly formed on the entire surface of the second substrate, or patterned thereon in a plural manner.

The first and the second substrates 12 and 14 are aligned such that the electron emission unit and the light emission unit face each other at a distance, and sealed to each other by way of a frit seal. The internal space between the first and the second substrates 12 and 14 is exhausted to be in a vacuum state, thereby completing an electron emission device.

With the above structure, when predetermined driving voltages are applied to the cathode electrodes 16 and the gate electrodes 20, electric fields are formed around the electron emission regions 24, and electrons are emitted from the electron emission regions 24. The emitted electrons collide against the phosphor layers 30a at the relevant pixels, and excite them, thereby displaying the desired images.

A method of manufacturing the electron emission device according to the first embodiment of the present invention will be now explained. The method commonly includes the steps of forming an electron emission unit at the first substrate, forming a light emission unit at the second substrate, and sealing the first and the second substrates to each other. The steps of forming a light emission unit at the second substrate, and sealing the first and the second substrates to each other are performed using the techniques well known in the art.

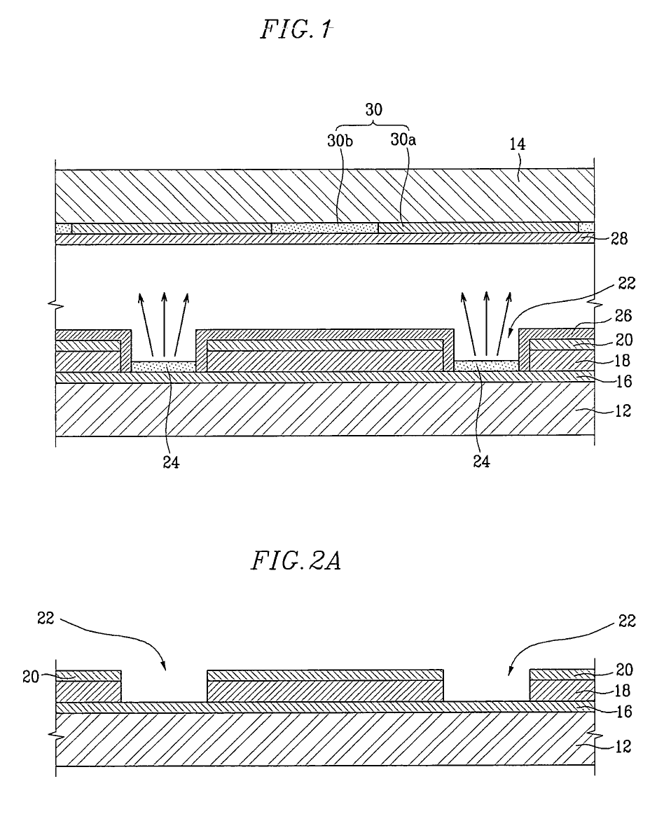

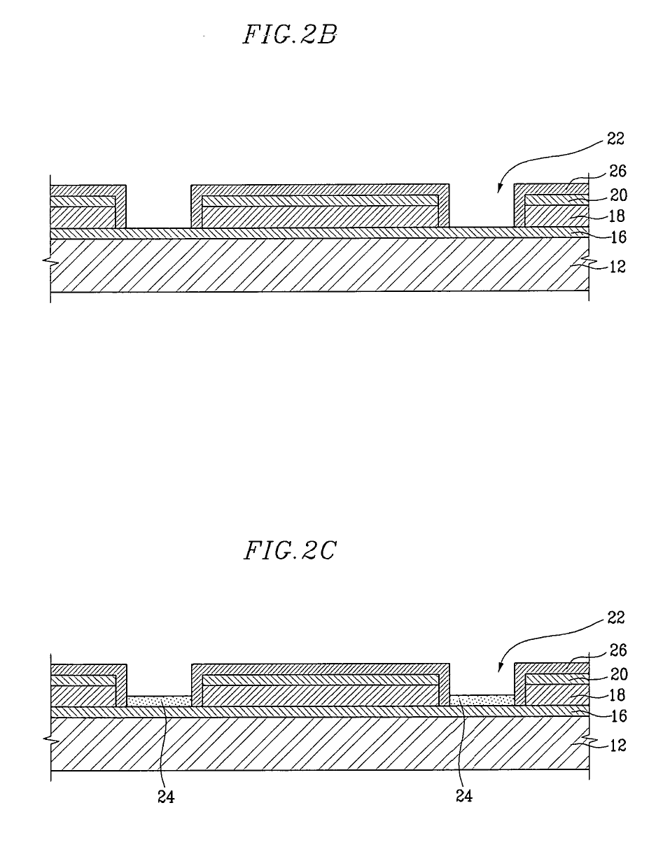

FIGS. 2A to 2C schematically illustrate the respective steps of processing the electron emission device according to the first embodiment of the present invention.

As shown in FIG. 2A, a transparent conductive film, for instance, based on ITO, is coated onto the first substrate 12 to form cathode electrodes 16. An insulating layer 18 with holes 22, and gate electrodes 20 with holes 22 are sequentially formed on the first substrate 12. The insulating layer 18 is formed through a thin or thick film formation process, and the gate electrodes 20 are formed through depositing a layer with an electrode material, such as chromium Cr, by a predetermined thickness, and patterning it.

As shown in FIG. 2B, a protective layer 26 is formed on the top surface of the gate electrodes 20, and the inner sidewall of the holes 22. The protective layer 26 is formed with a nonconductive material, such as amorphous silicon a-Si or photoresist by way of plasma enhanced chemical vapor deposition PECVD or coating.

The protective layer 26 exerts the same effect as the conventional sacrificial layer. Furthermore, when the electron emission material is fired, the protective layer 26 prevents the electrode surface from being oxidized.

As shown in FIG. 2C, the electron emission material is coated onto the cathode electrodes 16, and fired to form electron emission region 24 at the holes 22. The electron emission region 24 is formed with a carbon-based material, which is selected from carbon nanotube, graphite, diamond, diamond-like carbon, C₆₀ (fulleren), or combinations thereof. Also, the electron emission region 24 is formed with a nanometer size material, which is selected from nano-tube, nano-fiber, or combination thereof.

Thereafter, spacers (not shown) are formed on the first substrate 12. The first substrate 12 and the second substrate 14 with a light emission unit are sealed to each other at their peripheries via a sealant (not shown), and the internal space between them is exhausted to thereby complete an electron emission device.

In this embodiment, as the protective layer 26 is formed with a nonconductive material, it is not needed to remove the protective layer 26 after the formation of the electron emission regions 24. As the etching solution is not used, the electrodes and the electron emission regions are prevented from being damaged, thereby enhancing the device characteristics.

Electron emission devices according to second, third and fourth embodiments of the present invention will be now explained in detail. With the electron emission devices according to the second, third and fourth embodiments of the present invention, the second substrate has the same structure as that related to the first embodiment, but the first substrate differs in its structure from that related to the first embodiment.

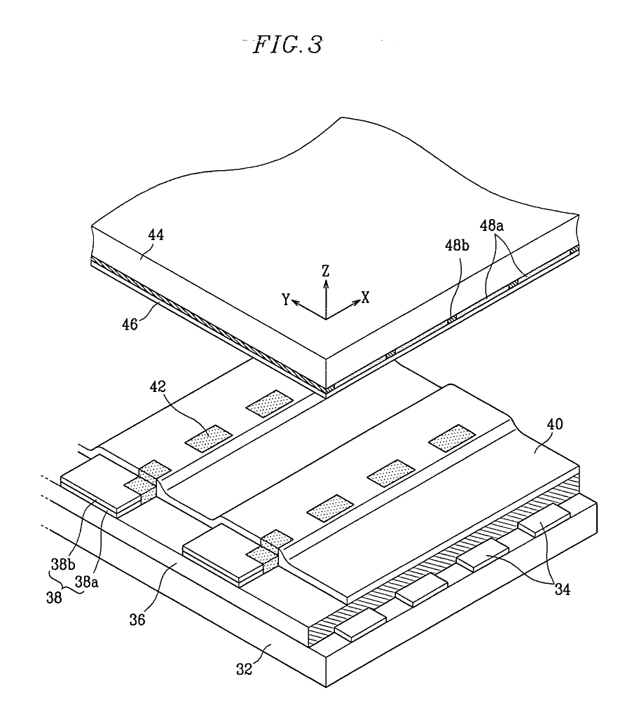

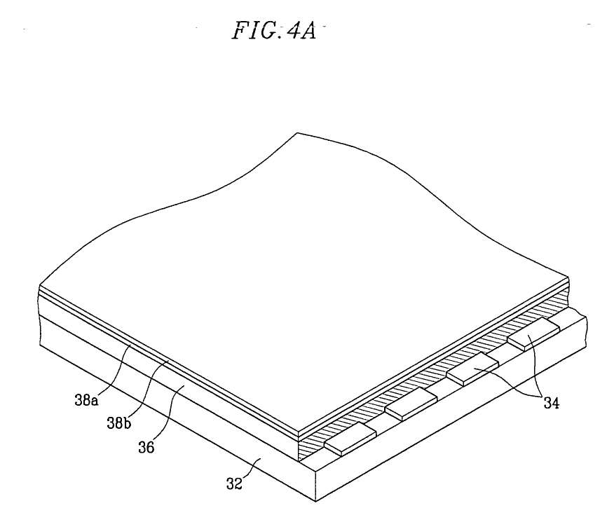

FIG. 3 is an exploded perspective view of an electron emission device according to a second embodiment of the present invention.

Gate electrodes 34 with a predetermined pattern (for instance, a stripe pattern) are formed on the first substrate 32 such that they are spaced apart from each other at a distance. An insulating layer 36 is formed on the entire surface of the first substrate 32 such that it covers the gate electrodes 34. Cathode electrodes 38 are formed on the insulating layer 36 while crossing the gate electrodes 34.

The cathode electrode 38 has a double-layered structure with first and second metallic layers 38a and 38b. A high conductive material, such as aluminum Al, is preferably used for forming the first metallic layer 38a contacting the insulating layer 36, and a high endurance material, such as chromium Cr, is preferably used for forming the second metallic layer 38b facing the second substrate 44. The first and the second metallic layers 38a and 38b are formed with a predetermined pattern, for instance, a stripe pattern.

That is, the cathode electrode 38 has a double-layered structure with a first high conductive metallic layer 38a, and a second high endurance metallic layer 38b. Accordingly, the first metallic layer 38a minimizes the occurrence of voltage drops, and the second metallic layer 38b minimizes the surface damage due to the electrical shocks, such as arcing.

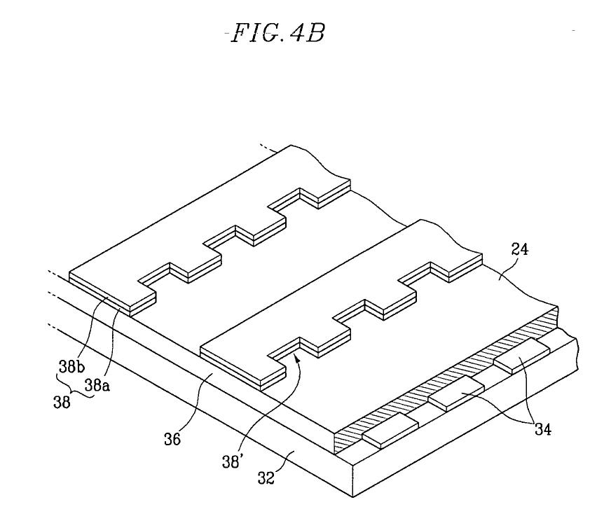

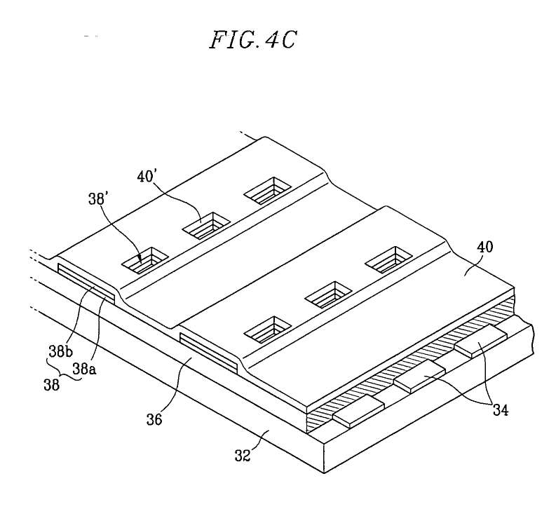

Furthermore, electron emission region accommodating members (see the reference numeral 38′ of FIG. 4B) are formed one-sidedly at the cathode electrode 38 through partially removing the cathode electrode 38. As the electron emission regions 42 are formed at the electron emission region accommodating members 38′, the contact area between the electron emission regions 42 and the cathode electrodes 38 can be increased.

A protective layer 40 is formed on the first substrate 32 while covering the cathode electrodes 38. Holes (see the reference numeral 40′ of FIG. 4C) are formed at the protective layer 40 corresponding to the electron emission region accommodating members 38′. The protective layer 40 is formed with a nonconductive material, such as amorphous silicon a-Si and photoresist.

The electron emission region 42 is located at the electron emission region accommodating member 38′ as well as at the hole 40′ (see FIG. 4C) of the protective layer 40. The electron emission region 42 is formed with a carbon-based material, which is selected from carbon nanotube, graphite, diamond, diamond-like carbon, C₆₀ (fulleren), or combinations thereof. Also, the electron emission region 42 is formed with a nanometer size material, which is selected from nano-tube, nano-fiber, or combination thereof.

A method of manufacturing the electron emission device according to the second embodiment of the present invention will be now explained. In this embodiment, the steps of forming a light emission unit at the second substrate, and sealing the first and the second substrates to each other may be performed using the techniques well known in the art.

FIGS. 4A to 4C illustrate the respective steps of processing the electron emission device according to the second embodiment of the present invention.

As shown in FIG. 4A, a transparent conductive material, such as ITO, is coated onto the first transparent substrate 32, and patterned to form gate electrodes 34 with a predetermined pattern, for instance, a stripe pattern. A transparent dielectric material is printed onto the entire surface of the first substrate 32 with the gate electrodes 34, dried, and fired to form an insulating layer 36.

A first metallic layer 38a is formed on the insulating layer 36 with aluminum Al by a predetermine thickness, for instance, 50-1000 nm. A second metallic layer 38b is formed on the first metallic layer 38a with chromium Cr by a predetermine thickness, for instance, 50-1000 nm. The first and the second metallic layers 38a and 38b may be formed through a thin film formation process, such as sputtering.

As shown in FIG. 4B, the first and the second metallic layers 38a and 38b are patterned in the direction crossing the gate electrodes 34 using a mask layer (not shown) and an etchant. At this time, cathode electrodes 38 are formed, and electron emission regions accommodating members 38′ are formed through partially removing the cathode electrodes 38.

As shown in FIG. 4C, a protective layer 40 is deposited onto the entire surface of the first substrate 32 with a nonconductive material, such as amorphous silicon and photoresist. The protective layer 40 is patterned to form holes 40′ exposing the electron emission region accommodating members 38′. When the protective layer is formed with amorphous silicon, it is patterned through a dry etching process, such as reactive ion etching. By contrast, when the protective layer is formed with photoresist, it is patterned through a common photolithography process.

Subsequently, a paste of a photosensitive electron emission material is thick-printed onto the protective layer 40, and ultraviolet rays are illuminated thereto through the first substrate 32. The protective layer 40 has a role of a light exposing mask, and the electron emission material within the electron emission region accommodating members 38′ and the holes 40′ of the protective layer 40 are selectively hardened. The non-hardened electron emission material is removed, and the hardened electron emission material is fired, thereby forming electron emission regions 42.

Thereafter, spacers (not shown) are formed on the first substrate 32, and the first substrate 32 and the second substrate 44 (FIG. 3) with a light emission unit are sealed to each other at their peripheries using a sealant (not shown). The internal space between the first and the second substrates 32 and 44 is exhausted to thereby complete an electron emission device.

In this embodiment, as the protective layer 40 is formed with a nonconductive material, it is not needed to remove the protective layer 40 after the formation of the electron emission regions 42. As the etching solution is not used, the electrodes and the electron emission regions are prevented from being damaged, thereby enhancing the device characteristics.

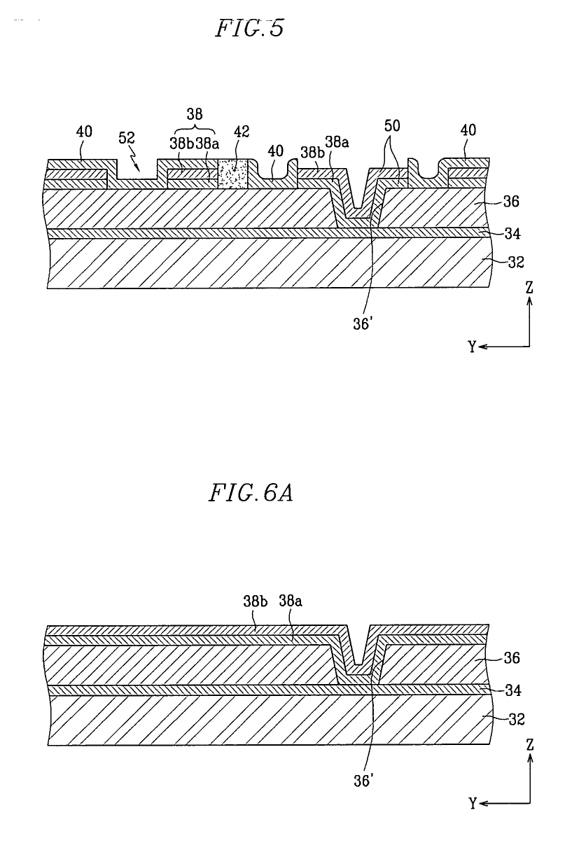

FIG. 5 is a cross sectional view of an electron emission device according to a third embodiment of the present invention.

The electron emission device according to the third embodiment of the present invention has the same structure as that related to the second embodiment except that it further has counter electrodes and electric field reinforcing members. In the respective embodiments, the same structural components are indicated by like reference numerals.

The counter electrode 50 is spaced apart from the electron emission region 42 between the cathode electrodes 38, and electrically connected to the gate electrode 34 through the hole 36′ of the insulating layer 36. Similar to the cathode electrode 38, the counter electrode 50 has a double-layered structure with a first aluminum-based metallic layer 38a, and a second chromium-based metallic layer 38b.

The counter electrode 50 pulls the voltage of the gate electrode 34 up to the electron emission region 42 such that stronger electric field can be applied to the electron emission region 42. That is, the counter electrode 50 facilitates the emission of electrons from the electron emission region 42.

Furthermore, an electric field reinforcing member 52 is formed opposite to the counter electrode 50 around the electron emission region 42 through partially removing the cathode electrode 38. The electric field reinforcing member 52 has a role similar to that of the counter electrode 50.

A method of manufacturing the electron emission device according to the third embodiment of the present invention will be now explained. In this embodiment, the steps of forming a light emission unit at the second substrate, and sealing the first and the second substrates to each other may be performed using the techniques well known in the art.

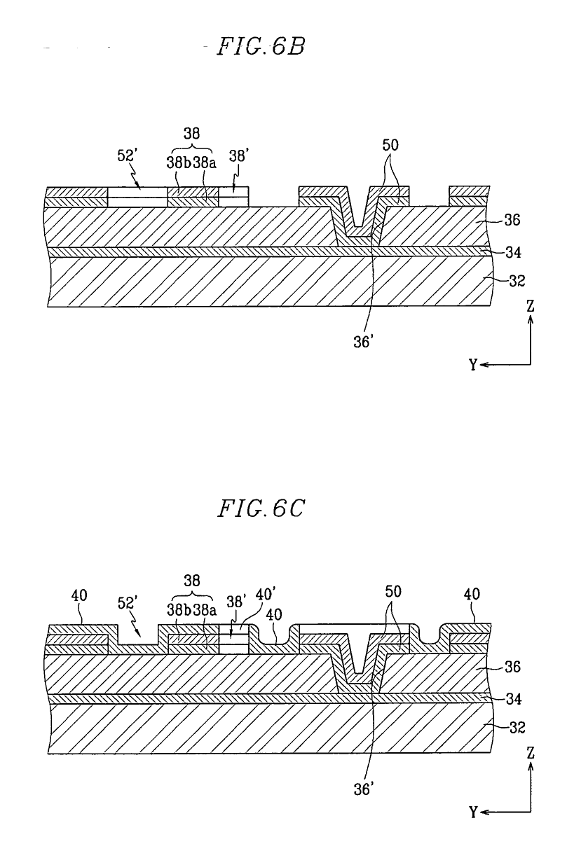

FIGS. 6A to 6C illustrate the respective steps of processing the electron emission device according to the third embodiment of the present invention.

As shown in FIG. 6A, a transparent conductive material, such as ITO, is coated onto the first transparent substrate 32, and patterned to form gate electrodes 34 with a predetermined pattern, for instance, a stripe pattern.

A transparent dielectric material is printed onto the entire surface of the first substrate 32 with the gate electrodes 34, dried, and fired to form an insulating layer 36. Holes 36′ are formed at the portions of the insulating layer 36 to expose the gate electrodes 34.

A first metallic layer 38a is formed on the insulating layer 36 with aluminum Al by a thickness of 50-1000 nm. A second metallic layer 38b is formed on the first metallic layer 38a with chromium Cr by a thickness of 50-1000 nm. As the first metallic layer 38a is deposited along the surface profile, it is also formed on the portions of the gate electrodes 34 exposed through the holes 36′ of the insulating layer 36.

As shown in FIG. 6B, the first and the second metallic layers 38a and 38b are patterned in the direction crossing the gate electrodes 34 with a predetermined pattern, for instance, a stripe pattern using a mask layer (not shown) and an etchant, thereby forming cathode electrodes 38. When the first and the second metallic layers 38a and 38b are patterned, electron emission region accommodating members 38′ and electric field reinforcing members 52′ are simultaneously formed. Furthermore, the portions of the first and the second metallic layers 38a and 38b over the holes 36′ are patterned to be larger than those holes 36′ (i.e., to overlap the insulting layer 36 around holes 36′) to thereby form counter electrodes 50.

As shown in FIG. 6C, a protective layer 40 is deposited onto the entire surface of the first substrate 32 with a nonconductive material, such as amorphous silicon and photoresist. The protective layer 40 is patterned to form holes 40′ exposing the electron emission region accommodating members 38′, and at the same time, to expose the counter electrodes 50. When the protective layer 40 is formed with amorphous silicon, it is patterned through a dry etching process, such as reactive ion etching. And, when the protective layer 40 is formed with photoresist, it is patterned through a common photolithography process.

Subsequently, a paste of a photosensitive electron emission material is thick-printed onto the protective layer 40, and ultraviolet rays are illuminated thereto through the first substrate 32. The protective layer 40 has a role of a light exposing mask, and the electron emission material within the electron emission region accommodating members 38′ and the holes 40′ of the protective layer 40 are selectively hardened. The non-hardened electron emission material is removed, and the hardened electron emission material is fired, thereby forming electron emission regions 42 (shown in FIG. 5).

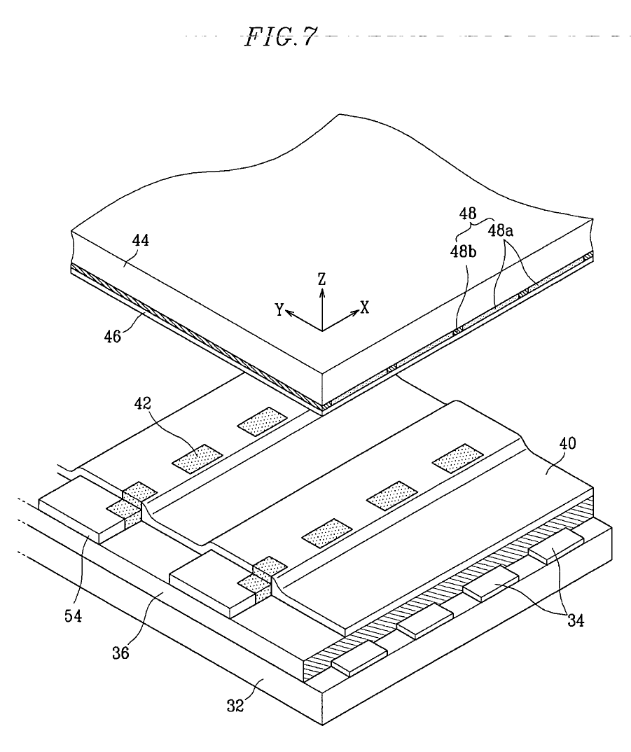

FIG. 7 is a cross sectional view of an electron emission device according to a fourth embodiment of the present invention. The electron emission devices according to the fourth embodiments of the present invention has the same structure as that related to the second embodiment, but the cathode electrodes 54 has one-layered structure. Thus, a method of manufacturing the electron emission device according to the fourth embodiment of present invention has the same step as that related to the method of manufacturing the electron emission device according to the second embodiment.

Similarly, it is possible that the electron emission devices according to the third embodiment of the present invention have cathode electrodes of one-layered structure.

As explained above, the gate electrodes 34 are formed with a stripe pattern, and the anode electrode 46 is singly formed over the phosphor layer 48a and black layer 48b on the second substrate. Alternatively, it is possible that the gate electrode is singly formed on the inner entire surface of the first substrate, and the anode electrodes are formed with a stripe pattern while crossing the cathode electrodes.

Furthermore, it is explained above that the electron emission device has cathode electrodes, gate electrodes, and an anode electrode. Alternatively, it is possible that the electron emission device further has electrodes, for instance, focus electrode in addition to those cathode, gate and anode electrodes.

Since the protective layer covers the electrodes arranged at the first substrate, it prevents the electrodes from being oxidized during the process of firing the electron emission material.

As the protective layer is formed with a nonconductive material, it is not needed to remove the protective layer. Accordingly, the problems made due to the removal of the sacrificial layer can be dispensed with. That is, the possible problems of increase in the line resistance, decrease in the amount of electron emission and increase in the contact resistance between the electron emission region and the cathode electrode are not made with the protective layer.

Furthermore, as the first metallic layer heightens the conductivity of the cathode electrode, the voltage drop in the cathode electrode is inhibited, and the electron emission from the electron emission region is increased. Consequently, the screen brightness is enhanced, and it becomes possible to make the low voltage driving.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. An electron emission device comprising:
cathode electrodes formed on a substrate;
gate electrodes placed over the cathode electrodes while interposing an insulating layer, the gate electrodes and the insulating layer having holes partially exposing the cathode electrodes;
electron emission regions being electrically connected to portions of the cathode electrodes exposed through the holes of the insulating layer and the gate electrodes; and
a nonconductive protective layer formed on a top surface of the gate electrodes and inner sidewall of the holes.

2. The electron emission device of claim 1 wherein the protective layer is formed with amorphous silicon a-Si or photoresist.

3. The electron emission device of claim 1 wherein the electron emission region is formed with a carbon-based material selected from one or more of the group consisting of carbon nanotube, graphite, diamond, diamond-like carbon, and C₆₀ (fulleren).

4. The electron emission device of claim 1 wherein the electron emission region is formed with a nanometer size material selected from one or more of the group consisting of nano-tube, and nano-fiber.

5. A method of manufacturing an electron emission device, the method comprising the steps of:
forming cathode electrodes on a substrate;
sequentially forming an insulating layer and gate electrodes with holes on the cathode electrodes, the holes exposing portions of the cathode electrodes;
forming a nonconductive protective layer on top surface of the gate electrodes and inner sidewall of the holes; and
forming electron emission regions on the portions of the cathode electrodes exposed through the holes.

6. The method of claim 5 wherein the protective layer is formed with amorphous silicon by way of plasma enhanced chemical vapor deposition or is formed with photoresist by way of coating.

7. An electron emission device comprising:
gate electrodes formed on a substrate;
cathode electrodes placed over the gate electrodes while interposing an insulating layer;
a nonconductive protective layer covering the cathode electrodes; and
electron emission regions formed with a photosensitive electron emission material, the electron emission regions being electrically connected to the cathode electrodes to emit electrons.

8. The electron emission device of claim 7 wherein the protective layer is formed with amorphous silicon a-Si or photoresist.

9. The electron emission device of claim 7 wherein electron emission region accommodating members are formed by way of partially removing the cathode electrodes, and the electron emission regions are located at the electron emission region accommodating members, respectively.

10. The electron emission device of claim 7 wherein the cathode electrodes have a double-layered structure with a first metallic layer, and a second metallic layer.

11. The electron emission device of claim 10 wherein the first metallic layer is formed with aluminum, and the second metallic layer is formed with chromium.

12. The electron emission device of claim 7 further comprising counter electrodes spaced apart from the electron emission regions with a distance between the cathode electrodes, the counter electrodes contacting the gate electrodes through holes formed at the insulating layer to make electrical connection with the gate electrodes.

13. The electron emission device of claim 12 wherein the counter electrodes have a double-layered structure with an aluminum-based layer, and a chromium-based layer.

14. The electron emission device of claim 12 further comprising an electric field reinforcing member formed opposite to the counter electrode and around the electron emission region.

15. A method of manufacturing an electron emission device, the method comprising the steps of:
forming gate electrodes on a substrate;
forming an insulating layer on the entire surface of the substrate such that the insulating layer covers the gate electrodes;
forming cathode electrodes on the insulating layer;
forming a nonconductive protective layer on the insulating layer overlaid with the cathode electrodes, and patterning the protective layer; and
coating an electron emission material overlaid with the protective layer and the substrate, and exposing the electron emission material to light by way of backside exposure to form electron emission regions.

16. The method of claim 15 wherein the step of forming a protective layer is performed by depositing an amorphous silicon layer through plasma enhanced chemical vapor deposition and patterning the amorphous silicon layer through dry etching.

17. The method of claim 15 wherein the step of forming a protective layer is performed by coating a photoresist layer and patterning the photoresist layer through photolithography process.

18. The method of claim 18 wherein the step of forming cathode electrodes is performed by sequentially depositing a first aluminum-based metallic layer and a second chromium-based metallic layer, and patterning the first and the second metallic layers.

19. The method of claim 15 wherein the step of forming cathode electrodes, electron emission region accommodating members are further formed by partially removing the cathode electrodes.

20. The method of claim 15 wherein the step of forming cathode electrodes, counter electrodes electrically connected to the gate electrodes are further formed.

21. The method of claim 15 wherein the step of forming cathode electrodes, electric field reinforcing members are further formed.
